(19) United States
(12) Patent Application Publication
(10) Pub. No.: US 2013/0130192 A1
(43) Pub. Date: May 23, 2013

(54) LUMINESCENT IMPRESSION MATERIAL

(71) Applicant: Medentic S.A., Wasserbillig (LU)

(72) Inventor: Fritz Schmitt, Wasserbillig (LU)

(73) Assignee: Medentic S.A., Wasserbillig (LU)

(21) Appl. No.: 13/747,415

(22) Filed: Jan. 22, 2013

Related U.S. Application Data
(63) Continuation of application No. PCT/EP2011/062463, filed on Jul. 20, 2011.

(30) Foreign Application Priority Data
Jul. 20, 2010 (DE) DE 2010 032 328.4

(51) Int. Cl. A61C 9/00

(52) U.S. Cl. CPC A61C 9/0006
USPC 433/34; 252/301.16; 252/301.4 R; 252/301.6 S; 252/301.35; 252/301.36; 433/214

(57) ABSTRACT

A physiologically compatible impression material comprises 0.005 wt % to 4.99 wt %, preferably 0.01 wt % to 1.0 wt %, and particularly preferably 0.025 wt % to 0.25 wt % of at least one luminescent material.

### CROSS REFERENCES TO RELATED APPLICATIONS

This application is a continuation of international patent application PCT/EP2011/062463, filed on Jul. 20, 2011, designating U.S., which international patent application has been published in German language and claims priority from German patent application DE 10 2010 032 328.4, filed on Jul. 20, 2010. The entire contents of these priority applications are incorporated herein by reference.

### BACKGROUND OF THE INVENTION

The present invention relates to a physiologically compatible impression material, a process for the production of such an impression material, an impression tray and/or carrier for insertion in an impression tray, a mold, and a use of such an impression material.

Physiologically compatible impression materials are known per se and are used for example in dentistry for the production of impressions of the jaw or a part of the jaw. Based on these impressions, models of the jaw or a part of the jaw can be made, based upon which dental prosthetics or inlays can be prepared. Such materials can also be used in a similar manner for the production of impressions of other body parts, such as for the production of prosthetics. Another area of application of such materials is the production of so-called oto-prosthetics or ear molds for hearing aids.

As a result of the fact that the production of e.g. a tooth replacement takes place on the basis of a cast of an impression, the accuracy with which, for example, the tooth replacement can be manufactured is necessarily limited. In order to solve this problem, recent times have often seen the proposition of digital systems based on cameras in the field of dentistry, which digital systems should serve to capture one or more teeth or a whole jaw arch and to reproduce this in the form of digital data. By way of example, a crown can then be machined on the basis of this data.

Even though a certain amount of success was obtained up until now by using such techniques, it was found that these techniques also do not yet supply optimal results as a result of shadows being cast in particular, and also as a result of insufficient illumination of specific regions.

In order to solve these problems, the present applicant has developed a method which is based on a combination of a measurement method on an optical basis and the use of specific impression materials. Generally speaking, impressions are taken using luminescent impression materials and then measured by means of optical methods. By way of example, this method is described in the yet to be laid-open application PCT/EP2009/006474, the entirety of which is incorporated herein by reference.

In order to carry out this method, impression materials having specific optical properties, and particularly specific luminescence properties, are required.

### SUMMARY OF THE INVENTION

It is therefore an object of the present invention to describe an impression material that is specifically designed for application in the aforementioned method.

Another object of the present invention is to describe a method for the production of such an impression material.

Another object of the present invention is to describe an impression tray for the production of an impression of at least one tooth and/or a carrier for insertion in an impression tray for application in the aforementioned method.

Another object of the invention is to describe a mold made from an impression material for application in the aforementioned method.

Another object of the present invention is to describe a use for an impression material.

The object of the invention is achieved by means of a physiologically compatible impression material containing 0.005 wt % to 4.99 wt %, preferably 0.01 wt % to 1.0 wt %, and particularly preferably 0.025 wt % to 0.25 wt % of at least one luminescent material. Specifically, the luminescent material is present in an amount of approximately 0.1 wt %.

The term physiologically compatible impression material is understood to mean a material that is suitable for the production of impressions of structures in or on the human or animal body. Such impression materials are known per se to the person skilled in the art and are commercially available from various suppliers. In particular, such an impression material should induce no toxicity, and to the extent possible, no allergic or irritating reactions in or on the human body. The consistency of the impression material is hereby limited only in that it must be flowable enough on one side to form a sufficiently precise and detailed impression, but dimensionally stable enough on the other side to retain the form of the impression after the material is removed from the structure in or on the human or animal body. A more precise description of the physical properties of dental impression materials can be found, for example, in ISO 4823, the disclosure of which is incorporated herein by reference in its entirety, with the materials being classified based on their viscosity into four classes, from type 0 (very high viscosity) to type 3 (low viscosity).

When appropriate, the material can also be designed in such a way that it cures and/or becomes solid while the impression is being taken. In this case, the material must be designed so that it can be removed from the human or animal body even after it has fully cured without causing any damage to the structure to be measured. The curing may thereby take place due to a chemical reaction, usually a polymerization reaction. In such cases, the curing is generally irreversible. However, it is also conceivable that the curing and/or solidification could take place in a reversible manner, for example, by means of solidification due to temperature change or a magnetorheological or electrorheological effect resulting from the application of magnetic or electrical fields, with the material in such cases containing any auxiliary materials that might be necessary.

Within the scope of the invention, the term luminescent material is understood to refer to any material that is capable of emitting light. This emission of light can thereby take place as a response to an external stimulus such as fluorescence or phosphorescence after excitation by irradiation with light of a given wavelength, but also due to internal processes, e.g. in the form of chemiluminescence resulting from a chemical reaction. What is of vital importance is that the luminescence must remain essentially constant throughout the measurement period.

Among luminescent materials, chemiluminescent or phosphorescent materials are particularly preferable, as these yield an impression material that can be excited before it is brought into contact with the human structure, and then, for example, after it has penetrated into difficult-to-reach cavities, produces additional luminescence in order to illuminate this area for measurement as well. The luminescent materials may be present in particulate form, but they may also be dissolved in the impression material.

Within the scope of the invention, the term light is understood to refer to both light in the visible range and electromagnetic radiation in the infrared or ultraviolet range, whereby this radiation must be selected in such a manner that it does not damage the structure to be measured in or on the human or animal body.

The materials according to the invention may be mixed with the luminescent materials either immediately at the time of production or shortly before application. In the latter case, the material and the luminescent material are delivered in the form of a two-component system to the dentist or dental technician, who then mixes the two components. In the case of a two-component system, it is preferable for the material and the luminescent material to be in (a) container(s) that make(s) mixing of the two components easier. Although designing the material as a two-component system is particularly suitable for materials in which chemoluminescent materials are used, with the mixing of the components in particular giving rise to luminescence, this configuration can also be beneficial in other materials, for example in order to prevent sedimentation of luminescent particles during storage.

It has been found that the above-mentioned impression materials are particularly well-suited for the measuring method developed by the present inventor, because on the one hand, the luminescent material is present in an amount sufficient to ensure uniform illumination of the area to be measured, but on the other hand, the other optical properties of the impression material are not negatively affected because of the relatively low content of luminescent material.

The impression materials of the invention are hereby preferably configured so as to be as permeable as possible to light in the wavelength range emitted by the luminescent material in order to obtain a high luminescent light yield. The impression materials are also preferably configured so as to be as permeable as possible to any light that may be used to excite luminescence if necessary, in order to ensure that the excitation throughout the entire material is as uniform as possible. In the relevant wavelength ranges, the material should preferably show transmission of at least 50%, and preferably at least 60%, more preferably at least 75%, and even more preferably at least 85%, with a transmission thickness of 1 cm. An example of a transparent impression material that can be used as the starting material for producing the material according to the invention is an impression material sold commercially by the company Dreve, Unna, Germany, under the name Fresh™ Clear.

In one embodiment of the invention, the luminescent material is selected from the group consisting of the anthraquinone derivatives, the coumarin derivatives, luminol, perylene, coelenterazine, Latia luciferin, luciopterin, Photinus luciferin, fluorescein, the fluorescein derivatives, the alkali metal and alkaline earth metal aluminates, the zinc sulfides, and mixtures thereof. If applicable, the alkali metal and alkaline earth metal aluminates may be doped. Preferred materials for doping in this case are the transition metals and the rare earth metals (with the rare earth metals alone being used in frequent cases).

Such materials are known per se to the person skilled in the art and are commercially available, e.g. under the name MACROLEX® from Lanxess (Germany), in the form of the LumiNova® Pigments from Nemoto (Japan), or in the form of fluorescent pigments manufactured by RC TriTec or Permalight.

In case of the use of particulate luminescent materials (generally referred to as pigments), it is advantageous if these materials show a surface modification so as to increase compatibility with the impression material. Moreover, in case of the use of pigments, it is advantageous if the pigments have a particle size of less than 5 μm, as this ensures that the optical properties of the material are affected only to a very minimal extent.

It has been found that the above-mentioned luminescent materials are particularly well-suited for the materials according to the invention, because they still provide favorable light output despite the small amount of luminescent material used, and at the same time are harmless to the human body in the concentration ranges used.

In a preferred embodiment, the impression material contains a material selected from the group consisting of the alginates, the hydrocolloids, the polyethers, the silicones, and mixtures thereof, and even more preferably, from the group consisting of the A silicones, the C silicones, and mixtures thereof.

Such materials are known per se to the person skilled in the art and are commercially available.

The above-described method developed by the applicant is particularly well-suited for the measurement of human teeth. The materials mentioned above have been widely used for some time in dentistry as impression materials, so the use thereof is known to be safe and effective.

In a further embodiment of the above-mentioned measure, the impression material contains a mixture of at least one organopolysiloxane having at least two unsaturated groups in the molecule and at least one organohydrogenpolysiloxane having at least two Si-bound hydrogens in the molecule.

This use of such a mixture provides an impression material with which particularly favorable impressions can be obtained. If desired, a chemical reaction may also be induced between the two substances, thus curing the impression material, so that the user is provided if necessary with a physical impression in addition to the measured digital data. For a more detailed discussion of organopolysiloxane-based impression materials, also see e.g. J. M. Powers, R. L. Sakaguchi: Craig's Restorative Dental Materials, Mosby 2006.

In a further embodiment of the above-mentioned measure, the material contains at least one polymerization initiator that is selected from the group consisting of the platinum catalysts, the photoinitiators, and mixtures thereof.

By adding a polymerization initiator, the compound can be cured, so that a user is provided, in addition to a digital data set, with a physical impression for later adjustment with respect to the digital data or for preparation of a model.

The initiation of polymerization may hereby take place by any means known to the person skilled in the art. For example, initiation may take place by mixing in of a catalyst such as a platinum catalyst as is known for commonly-used two-component impression materials, or initiation of polymerization may be induced via a photoinitiator by irradiation with light. The use of a photoinitiator is particularly preferred, because on the one hand, the material remains stable in long-term storage as a single-component material, and on the other hand, as the material is irradiated with light in order to carry out the above-mentioned measurement method, curing of the material can also be initiated simultaneously with excitation of luminescence. If a photoinitiator is used, it is also possible to configure the impression material in the form of a two-component system and to mix the photoinitiator with the impression material only shortly before application, for example in order to improve storage stability. In the case of a multicomponent system, one of the components may consist of any two of the ingredients impression material/polymerization structure/luminescent material, while the third ingredient respectively constitutes the second component. It is also possible for each ingredient to form an individual component, with all of the components being mixed prior to use.

In a further embodiment of the invention, the impression material contains at least one filler, with the filler preferably being selected from the group consisting of quartz, cristobalite, zirconium silicate, the montmorillonites, the zeolites, aluminium oxide, zinc oxide, barium sulfate, calcium carbonate, the glass powders, the plastic powders, silica, and mixtures thereof.

Addition of the above-mentioned fillers is advantageous, as this makes it possible to adjust as precisely as possible the flowability of the material, and if necessary its stability, during and/or after taking the impression. The fillers are preferably present in an amount, and particularly have a particle size, such that the optical properties of the impression material are not negatively affected.

In a further embodiment of the invention, the impression material contains at least one silicone oil.

It has been found that the flowability of the impression material can be positively affected by adding silicone oils.

In a further embodiment of the invention, the impression material comprises the following components:

a) at least one organopolysiloxane having at least two unsaturated groups in the molecule, preferably polyvinyl methyl siloxane;

b) at least one organohydrogenpolysiloxane having at least two Si-bound hydrogens in the molecule, preferably polymethyl hydrogen siloxane;

c) silica, preferably fumed silica;

d) at least one platinum catalyst that catalyzes the crosslinking of components a) and b); and

e) at least one luminescent material.

In a further embodiment of the invention, the impression material comprises the following components:

a) at least one organopolysiloxane having at least two unsaturated groups in the molecule, preferably polyvinyl methyl siloxane;

b) at least one organohydrogenpolysiloxane having at least two Si-bound hydrogens in the molecule, preferably polymethyl hydrogen siloxane;

c) silica, preferably fumed silica;

d) at least one photoinitiator for crosslinking of components a) and b); and

e) at least one luminescent material.

The components of the two materials should preferably be present in the following amounts:

5-20 wt % of organopolysiloxane having at least two unsaturated groups in the molecule;

1-10 wt % of organohydrogenpolysiloxane having at least two Si-bound hydrogens in the molecule;

20-70 wt % of silica;

0-5 wt % of luminescent material; and

0.01 wt % of photoinitiator and/or platinum catalyst.

A further embodiment of the impression material may, in addition to the at least one luminescent material, comprise one, several, or all of the following components:

a) organopolysiloxanes having two or more vinyl groups in the molecule;

b) low-molecular vinyl- and ethoxy group-containing QM resins and/or mixtures of QM resins in organopolysiloxanes;

c) organopolyhydrogensiloxanes having at least two SiH-groups in the molecule;

d) a noble metal catalyst, such as platinum-siloxane complexes;

e) metal oxide powders such as aluminium oxide, zirconium oxide, or titanium dioxide, preferred particle size: <2 μm;

f) organopolysiloxanes having at least one vinyl group in the molecule;

g) organopolysiloxanes without reactive groups;

h) oils or other softeners such as paraffin oils;

i) reinforcing fillers (with treated and untreated surfaces) such as fumed or precipitated silica and silicon-aluminium mixed chlorides;

j) non-reinforcing fillers (with treated and untreated surfaces) such as quartzes, cristobalite, diatomaceous earths, kieselguhrs, calcium carbonates, talc, zeoliths, sodium aluminium silicates, glass powders;

k) further additives and common excipients, auxiliaries, and colorants (inorganic and/or organic pigments) such as moisture-binding agents, hydrophilizing agents, stabilizers, hydrogen absorbers, etc.; and

l) inhibitors such as acetylenically unsaturated alcohols or vinyl group-containing, aliphatic, or cyclic polysiloxanes/oligosiloxanes/disiloxanes.

In a further embodiment, the impression materials may, in addition to the at least one luminescent material, comprise one, several or all of the following components:

a) organopolysiloxanes having two or more vinyl groups, viscosity range: 100-350,000 mPa*s;

b) low-molecular vinyl- and ethoxy group-containing QM resins and/or mixtures of QM resins in organopolysiloxanes, viscosity range: 150-65,000 mPa*s;

c) organopolyhydrogensiloxanes containing at least two SiH-groups in the molecule, SiH-content: 0.1-15 mmol/g (preferably 2-10 mmol/g);

d) (a) noble metal catalyst(s);

e) organopolysiloxanes having at least one vinyl group in the molecule;

f) organopolysiloxanes without reactive groups, viscosity: 50-100 mPa*s;

g) oils and other softeners;

h) reinforcing fillers with treated and untreated surfaces;

i) mixtures of reinforcing fillers with organopolysiloxanes, viscosity range: 100-2,000 m Pa*s;

j) non-reinforcing fillers with treated and untreated surfaces;

k) further additives and common excipients, auxiliaries, and colorants;

l) inhibitors; and

m) metal oxide powders such as titanium dioxide; particle size smaller than 50 μm, preferably smaller than 20 μm, and particularly preferably smaller than 2 μm (such as titanium dioxide available under the trade name Aeroxid/Degussa).

It has been found that the use of the above-mentioned components makes it possible to produce impression materials that are particularly well-suited for use in the method developed by the inventor.

The invention also relates to a process for the production of a physiologically compatible impression material according to the invention in which the luminescent material is mixed with a physiologically compatible impression material.

In an embodiment of the invention, the impression material comprises at least one silicone, and when mixing the impression material with the at least one luminescent material, at least one solvent selected from polymethyl methacrylate, dichloromethane, and trichloromethane is added.

In the above-mentioned measure, the luminescent material is preferably dissolved or suspended in the solvent at a relatively high dilution ratio such as 0.002-0.010% and then mixed with the impression material.

It has been found that by means of the above-mentioned measures, materials can be produced in which the luminescent material is distributed as homogenously as possible, which leads to particularly accurate measurement in the measurement method developed by the inventor.

The invention also relates to an impression tray for the production of an impression of at least one tooth that comprises a physiologically compatible impression material according to the invention.

Such an impression tray can be used particularly advantageously in the measuring method developed by the inventor.

The invention also relates to a carrier for insertion into an impression tray, the carrier comprising a physiologically compatible impression material according to the invention.

The invention also relates to a mold that consists of a physiologically compatible impression material according to the invention and is configured in a shape that can essentially enclose the human jaw either completely or partially.

By means of the above-mentioned measures, it is possible to keep pre-prepared amounts of the impression material ready for direct application in the above-mentioned measuring process.

In an embodiment of the above-mentioned measure, the physiologically compatible impression material according to the invention can be cured, and at least a part of the physiologically compatible impression material on the outside of the mold is already cured.

In this manner, as the material is cured on the outer side of the mold, this forms a small bowl for the impression material, which, inter alia, prevents undesirable distortion of the impression material on the outer side.

The invention also relates to the use of the impression material for producing an impression of a structure in or on the human or animal body, with the structure preferably being selected from the group consisting of one or more teeth, a jaw, or a part of the jaw.

This method is advantageous in that by using the impression material according to the invention, digitized data of a structure in or on the human body can be generated that are superior to the results of conventional methods.

It is understood that the mentioned features and those yet to be explained below can be used not only in the respectively specified combination, but also in other combinations or on their own, without departing from the scope of the present invention.

### BRIEF DESCRIPTION OF THE DRAWINGS

The invention will be explained in the following by means of examples and with respect to the attached figures. The figures are as follows:

FIG. 1 shows a carrier for insertion into an impression tray containing a dental impression material;

FIG. 2 shows a mold composed of a physiologically compatible impression material.

### DESCRIPTION OF PREFERRED EMBODIMENTS

### Example 1

A fluorescent impression material was produced using the ingredients shown in Table 1. For this, the luminescent material was dissolved in the Orthocryl (polymethyl methacrylate) and mixed with the Fresh™ Clear impression material in a vacuum. After the mixing process was completed, the viscosity of the composition was adjusted to the desired value by adding silicone oil. In the present case, a two-component material was used, so that after mixing, the material had to be placed in an impression tray and immediately used for taking an impression.

TABLE 1

| Component | Amount | |
|---|---|---|
| Fresh ™ Clear* | 200 | g |
| MACROLEX fluorescent REG** | 0.002 | g |
| Orthocryl*** | 0.02 | mL |

| | |
|---|---|
| Silicone oil | as needed |

*Impression material commercially available from Dreve, Germany
**Fluorescent dye commercial available from Lanxess
***Liquid polymethyl methacrylate commercially available from DENATURUM

### Example 2

Using the ingredients shown in Table 2, a further fluorescent impression material was produced by a method similar to that of Example 1. In contrast to the material of Example 1, this was a light-curable material.

TABLE 2

| Components | Amount (wt. %) | |
|---|---|---|
| Organopolysiloxane with two terminal | 15 | wt. % |
| vinyl groups | | |
| Low-molecular vinyl- and ethoxy- | 15 | wt. % |
| group-containing QN resin | | |
| Organohydrogenpolysiloxane containing | 10 | wt. % |
| at least two Si-bonded | | |
| hydrogens in the molecule | | |
| Catalysts for accelerating the | 0.08 | wt. % |
| hydrosilylation reaction | | |
| Non-reinforcing fillers (silica) | 50 | wt. % |
| Moisture-binding agents | 4 | wt. % |
| Additional additives and auxiliaries | 5 | wt. % |
| Fluorescent pigment | 0.1 | wt. % |
| Photoinitiators | 0-0.1 | wt. % |

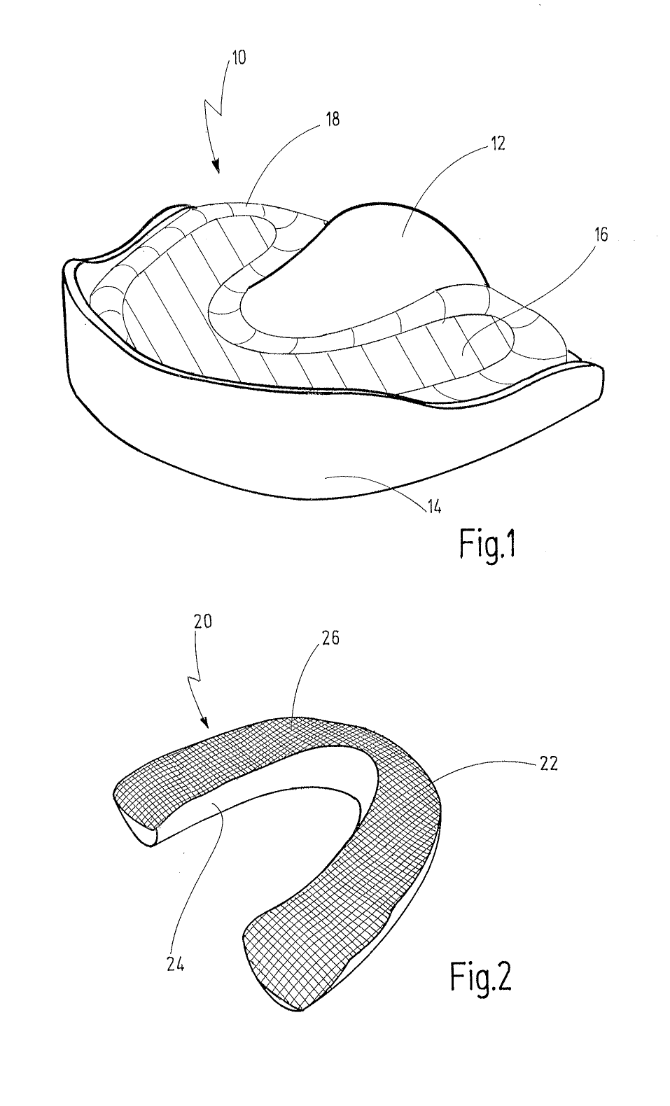

In FIG. 1, a carrier for insertion into an impression tray is denoted in its entirety by reference numeral 10. The carrier comprises a bottom plate 12 having an external contour that is essentially modeled after the human jaw. At its outer external contour, the bottom plate 12 is limited by a wall 14, which, inter alia, ensures that during the production of an impression, the material remains pressed against the jaw of which an impression is to be taken. Moreover, a physiologically compatible impression material 16 is arranged on the bottom plate. This impression material 16 can, for example, be an impression material according to Example 1.

In order to prevent a patient of whom an impression is to be taken from biting through to the bottom plate, and in order to ensure that there is a uniform distance between the dental arch and e.g. the wall 14, the impression material is further cured in an edge area 18 and thus shows a notably higher degree of hardness than the non-cured impression material 16 in the center.

For use in a method for the digital measurement of a jaw, the carrier is composed e.g. completely or partially of a transparent material and/or comprises optical elements that are inserted into it. Moreover, it is also possible to include illumination elements for illuminating the impression material or optical sensors for measuring the luminescence emitted by the impression material, or both, in the carrier. In this case, the carrier also comprises electrical contacts to connect it to a corresponding impression tray.

In order to carry out the measuring method, the carrier is inserted into a suitable impression tray. Alternatively, however, the material can also be inserted into the impression tray in the form of a mold. A suitable impression tray is described for example in PCT/EP2009/006474 as mentioned above. As the carrier used in this case is transparent, the impression tray has illumination elements in order to illuminate the impression material and optical sensors for measuring the light emitted from the impression material. For example, in order to measure a jaw, the impression tray illuminates the material placed in the carrier and thus causes it to e.g. phosphoresce. The user then presses the jaw to be measured into the impression material. By means of the impression tray, the light emitted from the impression material is then measured. The light measured may thereby originate directly from the luminescence of the material, making it possible for the digitized model of the jaw to be determined via the specific luminescence, i.e. the light yield per spatial unit. However, it is also conceivable that the reflections of the structures to be measured can be measured in the form of picture information, in which case the luminescent material provides particularly favorable illumination, and the digital model can be calculated based on the picture information. The method can also be based on a combination of these two measurements.

FIG. 2 shows a mold composed of a physiologically compatible impression material designated in its entirety by reference numeral 20. The mold 20 consists entirely of a luminescent impression material 22, e.g. an impression material according to Example 1. In order to ensure the proper insertion into the impression tray and prevent deformation of the mold 20, the impression material 22 is at least partially cured on one external side 24, which causes a kind of small bowl for the impression material to be formed. On its upper side 26, the mold 20 further comprises a grid pattern, which serves to generate further data in optical measurement.

Such a mold 20 can be inserted either into a commonly known impression tray or into an impression tray that is quite specifically designed for carrying out a method for the collection of digital data on a tooth of the human jaw, in order to provide an impression tray that contains a physiologically compatible impression material. This takes place according to common methods that are well-known to the person skilled in the art. The provision of such a mold 20 provides advantages such as preventing air inclusions between the impression tray and the impression material that could possibly interfere with the optical measurement to be conducted.

What is claimed is:

1. A physiologically compatible impression material, comprising 0.005 wt % to 4.99 wt %, preferably 0.01 wt % to 1.0 wt %, and particularly preferably 0.025 wt % to 0.25 wt % of at least one luminescent material.

2. The impression material of claim 1, wherein said luminescent material is selected from the group consisting of the coumarin derivatives, luminol, perylene, coelenterazine, Latia luciferin, luciopterin, Photinus luciferin, fluorescein, the fluorescein derivatives, optionally doped alkali metal or alkaline earth metal aluminates, and optionally doped zinc sulfides and mixtures thereof.

3. The impression material of claim 1, comprising a material selected from the group consisting of the alginates, the hydrocolloids, the polyethers, the silicones, and mixtures thereof.

4. The impression material of claim 3, comprising a material selected from the group composed of the A silicones, the C silicones, and mixtures thereof.

5. The impression material of claim 4, comprising a mixture of at least one organopolysiloxane having at least two unsaturated groups in the molecule and at least one organohydrogenpolysiloxane having at least two Si-bound hydrogens in the molecule.

6. The impression material of claim 5, further comprising at least one polymerization initiator selected from the group consisting of the platinum catalysts, the photoinitiators, and mixtures thereof.

7. The impression material of claim 1, comprising at least one filler.

8. The impression material of claim 7, wherein said filler is selected from the group consisting of quartz, cristobalite, zirconium silicate, the montmorillonites, the zeolites, aluminium oxide, zinc oxide, barium sulfate, calcium carbonate, the glass powders, the plastic powders, silica, and mixtures thereof.

9. The impression material of claim 1, comprising at least one silicone oil.

10. The impression material of claim 1, comprising the following components:
a) at least one organopolysiloxane having at least two unsaturated groups in the molecule, preferably polyvinyl methyl siloxane;
b) at least one organohydrogenpolysiloxane having at least two Si-bound hydrogens in the molecule, preferably polymethyl hydrogen siloxane;
c) silica, preferably fumed silica;
d) at least one platinum catalyst for crosslinking of components a) and b); and
e) at least one luminescent material.

11. The impression material of claim 1, comprising the following components:
a) at least one organopolysiloxane having at least two unsaturated groups in the molecule, preferably polyvinyl methyl siloxane;
b) at least one organohydrogenpolysiloxane having at least two Si-bound hydrogens in the molecule, preferably polymethyl hydrogen siloxane;
c) silica, preferably fumed silica;
d) at least one photoinitiator for crosslinking of components a) and b); and
e) at least one luminescent material.

12. A method for the production of a physiologically compatible impression material of claim 1, wherein said at least one luminescent material is mixed with a physiologically compatible impression material.

13. The method of claim 12, wherein said impression material comprises at least one silicone, and wherein when mixing said impression material with said at least one luminescent material, a solvent selected from polymethyl methacrylate, dichloromethane, and trichloromethane is added.

14. An impression tray for the production of an impression of at least one tooth, containing a physiologically compatible impression material of claim 1.

15. A carrier for insertion in an impression tray, containing a physiologically compatible impression material of claim 1.

16. A mold consisting of a physiologically compatible impression material of claim 1 having a shape that is essentially modeled after the human jaw.

17. The mold of claim 16, wherein said physiologically compatible impression material can be cured and wherein at least a part of said physiologically compatible impression material is cured on an outer side of the mold.

18. A use of a physiologically compatible impression material of claim 1 for the production of an impression of a structure in or on the human or animal body.

19. The use of claim 18, wherein said structure is selected from the group consisting of one or more teeth, a jaw, or a part of a jaw.
